(19) United States
(12) Patent Application Publication
(10) Pub. No.: US 2005/0034314 A1
(43) Pub. Date: Feb. 17, 2005

(54) Razorblade assembly

(76) Inventor: Jarret Peter Cuisinier, Stanford, CA (US)

Correspondence Address: Jarret P. Cuisinier, #74, 6730 E. Hermosa Vista Dr., Mesa, AZ, 85215, US

(21) Appl. No.: 10/640,560

(22) Filed: Aug. 12, 2003

(51) Int. Cl. B26B 21/52

(52) U.S. Cl. 30/527

(57) ABSTRACT

The present invention provides a razorblade assembly having multiple faces for shaving. For example, the assembly has a handle and a rotatable razorblade unit with multiple distinct faces, at least one face having a guarded razorblade for use. Thereby, a user can utilize the same assembly for numerous shaves.

### FIELD OF INVENTION

This invention relates to razors, and more particularly, to reel safety razors used for the cutting of hair.

### BACKGROUND OF THE INVENTION

A variety of safety razors have been described in the prior art. These safety razors have configurations ranging from single blades with an attached handle to reel assemblies often times having eight individual blades or more. These reel assemblies are intended to allow a user to use the same razorblade assembly, be it a disposable or permanent system, for many shaves by rotating a magazine having multiple blades about an axis parallel to the blades. However, these reel razorblade assemblies have many associated problems and as a result have not gained popular acceptance despite their inherent cost advantages.

For example, much of the prior art discloses embodiments that reuse the same shaving area with only a substitutable and protruding new blade from a reel magazine. A few of the many such assemblies are disclosed in U.S. Pat. No. 3,722,091 (1973) to Gagnon, U.S. Pat. No. 3,430,341 (1969) to Choate, and U.S. Pat. No. 1,007,847 (1911) to Carlson. These assembly configurations can lead to an overused and unclean shaving area as only the blade is replaced despite numerous planned shavings for the area surrounding the blade. This problem is further amplified when the assembly is permanent in nature and is intended to be used with replacement blade magazines as the shaving area is still never replaced despite an even greater number of use cycles.

In much the same way, these and similar prior art (e.g. U.S. Pat. No. 3,137,940 (1964) to Curci) often disclose reel assemblies tightly enclosed with an overlapping “cover member.” This cover member is intended to shield the user from cuts caused by the inactive blades of the reel blade magazine. However, the tightly fitting nature of these covers can often lead to mechanical problems as cut hairs, dirt, and even dried blood can become wedged between the rotating magazine and the cover, leading to a stuck magazine device that often requires great effort to rotate. Furthermore, the somewhat sealed, container-like nature of many of these covered devices can frequently lead to unclean fluid getting trapped within the razorblade devices. This stagnate fluid can in turn harmfully affect sanitary conditions as well as negatively affect overall quality of use.

Finally, the prior art discloses cylindrically shaped reel magazine embodiments where the shaving target comes into direct contact with a cylinder having several razorblades along its circumference. Two notable examples of these cylinder embodiments in the prior art are Curci (1960) and U.S. Pat. No. 2,127,881 (1937) to Morris. Embodiments of this cylindrical nature are intrinsically limited because of their single-point contact with the shaving target. Thus, because of the cylinder's inherent single point of contact these embodiments cannot be additionally equipped with other advances in shaving technology including multiple blades, moisturizing strips, slanted blades, wear indicators, and the like—all of which offer superior performance and quality of use. Furthermore, these sometimes unshielded cylinder embodiments can as well be less safe for the user, as is the case of the multi-bladed Curci embodiment.

Accordingly, it is desirable to provide a reel razor assembly that provides a new surface area with each new blade.

It is also desirable to provide a shielded reel razor assembly that is both sanitary and resistant to mechanical difficulties.

It is further desirable to provide a reel razor assembly that provides a flat and safe surface area for shaving that allows the use of multiple blades, moisturizing strips, slanted blades, wear indicators, and the like.

### SUMMARY OF THE INVENTION

The present invention provides a razorblade assembly having multiple faces for shaving. In accordance with an exemplary embodiment of the present invention, the assembly is configured to have a handle and a rotatable razorblade unit with multiple distinct faces, at least one face having a guarded razorblade for use.

### BRIEF DESCRIPTION OF THE DRAWINGS

Additional aspects of the present invention will become evident upon reviewing the non-limiting embodiments described in the specification taken in conjunction with the accompanying figures, wherein like numerals designate like elements, and:

FIG. 1a is a side view of an embodiment of the razor assembly having two razorblade faces;

FIG. 1b is a top view of the same embodiment having a razor assembly possessing two razorblade faces;

FIG. 2 is a side view of an embodiment of the razor assembly having two faces—one with a razorblade and the other blank;

FIG. 3 is a side view of an embodiment of the razor assembly having three razorblade faces and a turn dial;

FIG. 4 is a side view of an embodiment of the razor assembly having three faces—two with razorblades and the other blank; and,

FIG. 5 is a front view of a three-faced cartridge embodiment.

### DETAILED DESCRIPTION

The following descriptions are of preferred exemplary embodiments only, and are not intended to limit the scope, applicability, or configuration of the invention in any way. Rather the following description provides a convenient illustration for implementing a preferred embodiment of the invention. Various changes may be made in the function and arrangement of elements described in the preferred embodiments without departing from the spirit and scope of the invention as set forth herein.

Generally, in accordance with a preferred embodiment of the present invention, a razorblade assembly capable of performing multiple shaves is provided. The assembly suitably comprises a handle and multiple, distinct surface areas for shaving. In a preferred embodiment, the assembly suitably contains three complete and independent faces and razorblade sets integrated on each, thereby allowing the user to use the same device for numerous shaves. For example, the assembly may have a handle attached to a rotatable triangular-shaped razorblade unit that possesses a razorblade set on each of the unit's three long, rectangular faces.

However, in accordance with alternate embodiments of the present invention, the razorblade unit may also be suitably configured to have a different number of razorblade sets or a different number of faces. For example, in the case of a three-faced unit, one face could remain blank so as to provide a safe area to be exposed during times of inactivity. Furthermore, the razorblade unit could have two faces or any other multiple number of faces.

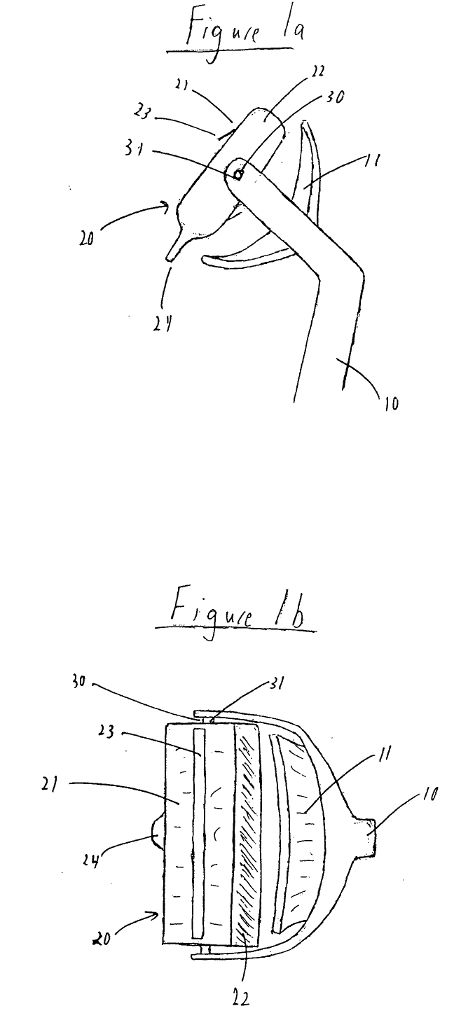

Thus, with reference to FIG. 1a and FIG. 1b, in accordance with an exemplary embodiment of the present invention, a handle 10, a razorblade unit 20, and a connection 30 are shown. In accordance with the present exemplary embodiment, handle 10 and most of razorblade unit 20 are composed of a polymer. However, in accordance with various alternate embodiments handle 10 and razorblade unit 20 could be substituted with alternative materials including composites, rubbers, metals, and the like. Moreover, and in accordance with various alternate embodiments, the size and shape of handle 10, razorblade unit 20, and connection 30 can vary as well.

Additionally and in accordance with an exemplary embodiment of the invention, handle 10 has shielding 11 to protect the user from the inactive blades. Furthermore, shielding 11 has holes 12 (not shown) to ensure effective draining during cleaning. Moreover, razorblade unit 20 is connected with handle 10 via connection 30. Connection 30 further allows entire razorblade unit 20 to rotate about pivot points 31 and to lock into positions effectively exposing one of faces 21. However, in accordance with an alternate embodiment of the present invention, razorblade unit 20 can be locked into separate pivot ranges via connection 30. Thus, razorblade unit 20 can pivot, letting faces 21 better follow the contours of the surface to be shaved. In addition, faces 21 are adapted to receive a cover (not shown) for times when they are inactive and unshielded.

Furthermore, with continuing reference to FIG. 1a and FIG. 1b and according to one aspect of the present exemplary embodiment, razorblade unit 20 has two faces 21 on opposite sides of a frame 22. Razorblade unit 20 further includes a razorblade set 23 on each of faces 21. Razorblade sets 23 each have one razorblade and these blades are both effectively attached to and guarded by frame 22. However, in accordance with an alternate embodiment of the present invention, razorblade sets 23 could include multiple razorblades in parallel.

Additionally, a lever 24 extends from frame 22. Lever 24 is present in the form of a linear member that can be grasped and moved to rotate razorblade unit 20 about connection 30 and selectively position one of faces 21 as an active face. However, in accordance with various alternate embodiments, lever 24 may be present in the form of a dial that is turned so as to rotate razorblade unit 20 and thereby properly control the position of faces 21. In this respect, it should be appreciated that any number of mechanisms now known or as yet unknown may be capable of selectively positioning a face and may be used while still falling within the scope of the present invention.

Thus, in accordance with an exemplary embodiment of the present invention and again in continuing reference to FIG. 1a and FIG. 1b, razorblade unit 20 suitably provides multiple faces 21 and razorblade sets 23 for numerous shaves. In use, razorblade unit 20 is positioned via locking connection 30 so as to desirably place one of faces 21 as an active face. Then, handle 10 is grasped and the active face and its razorblade set 23 are put in contact with the surface to be shaved. Subsequently and in typical fashion, handle 10 is moved so as to drag the active face and its razorblade set 23 across the target surface. After multiple uses and subsequent dulling of active razorblade set 23, lever 24 can be grasped and moved so as to replace the current active face with a new face of same razorblade unit 20, thereby creating a fresh active face and razorblade set 23 for many more shaves.

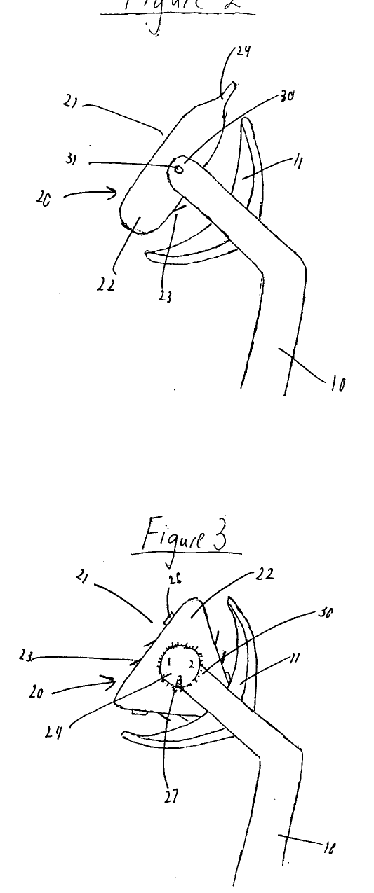

In accordance with an alternate embodiment of the present invention and with reference to FIG. 2, an embodiment again having two faces 21 is presented. Instead, however, one of faces 21 does not possess a razorblade set 23. Thus, razorblade unit 20 can be rotated via lever 24 and locked via connection 30 in a manner leaving no exposed razors, thereby eliminating the need for a protective cover during inactive times.

Now with reference to FIG. 3, a preferred embodiment of the invention is shown. This embodiment incorporates various supplementary features intended to optimize overall use of the invention for the user. However, various alternate embodiments of the present invention may omit some or all of these features, utilize another combination of these features, or utilize these and additional features not here described.

In accordance with one aspect of a preferred embodiment of the invention, razorblade unit 20 is triangular in shape, having three long faces 21 each with a razorblade set 23. Additionally, razorblade sets 23 each have two parallel razorblades. Moreover, each face 21 is equipped with integrated moisturizing strips 26, which are attached directly to frame 22. However, and in accordance with various alternate embodiments of the present invention, some or all of faces 21 could be similarly equipped with slanted blades, wear indicators, and other shaving technologies now known or not yet known-all of which can offer superior performance and quality of use. Furthermore, lever 24 is present in the form of a dial. Lever 24 is suitably connected with razorblade unit 20 so that when dial-shaped lever 24 is rotated, so does entire razorblade unit 20. In addition, dial-shaped lever 24 also has numberings 27 to help the user keep track of which blades have been used. Similarly, faces 21 could originally come with a protective covering (not shown) to aid in tracking the usage of faces 21. This covering would most likely be composed of paper or plastic and would likely attach to faces 21 through the use of an adhesive. Then, when the use of one of faces 21 was desired (thereby becoming a new active face), this covering could be pealed off. To further aid in the removal of the covering, an easily graspable, non-adhesive tab could be present. Thus, these coverings would help a user track face usage as well as ensure that faces 21 and razorblade sets 23 were sterile during shipping and during times when other faces 21 were in use. Additionally, and as previously described for an exemplary embodiment, faces 21 could further be adapted to receive a cover (not shown) for times when they are both inactive and unshielded.

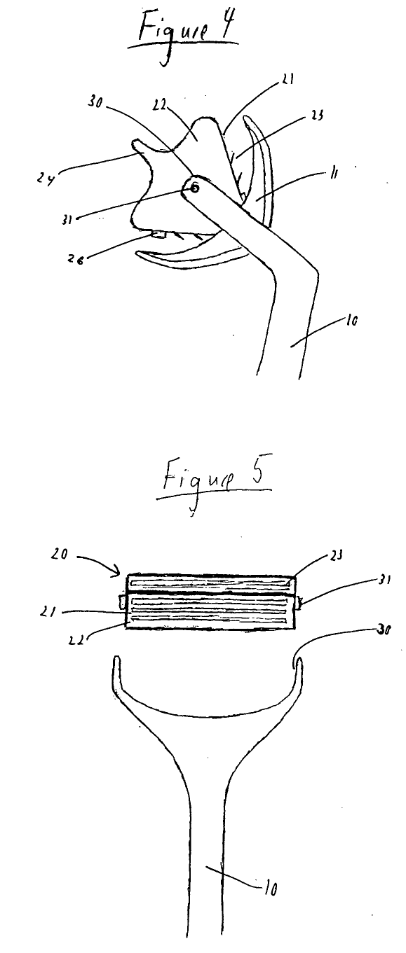

In an alternative embodiment of the present invention and now with reference to FIG. 4, an embodiment again having three faces 21 is presented. Instead, however and in a configuration similar to the embodiment presented in FIG. 2, one of faces 21 does not possess a razorblade set 23 or a moisturizing strip 26. Thus, razorblade unit 20 can be rotated via linear lever 24 and locked via connection 30 in a manner leaving no exposed razors, thereby eliminating the need for a protective cover during inactive times. Furthermore, slits (not shown) in shielding 11 allow lever 24 to always be graspable no matter how razorblade unit 20 is positioned.

With reference now to FIG. 5, another alternate embodiment utilizing a cartridge system is shown. In accordance with this alternate embodiment, connection 30 allows razorblade unit 20 to be removed from handle 10. Thus, handle 10 is now able to likewise receive a new and fresh razorblade unit 20 when all faces 21 and razorblade sets 23 have been sufficiently used on old razorblade unit 20.

Thus, while the principles of the invention have been described in illustrative embodiments, many combinations and modifications of the above-described structures, arrangements, proportions, the elements, materials, and components, used in the practice of the invention in addition to those not specifically described may be varied and particularly adapted for a specific environment and operating requirement without departing from those principles.

1. A razorblade assembly, comprising:
a handle;
a shielding;
a razorblade unit, wherein said razorblade unit comprises multiple faces, wherein at least one of said faces comprises an integrated and guarded razorblade; and,
a connection between said handle and said razorblade unit, wherein said shielding is integrated with said handle, wherein said shielding covers the majority of said razorblade unit, wherein said razorblade unit is rotatable about an axis parallel to said faces beneath said shielding via said connection and wherein said faces are selectively lockable via said connection in an area uncovered by said shielding.

2. The razorblade assembly of claim 1, wherein one of said faces has a blank face.

3. The razorblade assembly of claim 2, wherein said blank face further comprises a handle for gripping and rotating said razorblade unit about said axis.

4. The razorblade assembly of claim 1, wherein said razorblade unit further comprises a guarded razorblade on each of said faces.

5. The razorblade assembly of claim 4, wherein said razorblade assembly further comprises a razorblade cover lockable in one of a closed position and an open position over an area uncovered by said shielding.

6. The razorblade assembly of claim 1, wherein said razorblade assembly further comprises a handle for gripping and rotating said razorblade unit about said axis.

7. The razorblade assembly of claim 6, wherein said handle is a dial located on said axis at an end of said razorblade unit that can be grasped and rotated to rotate said razorblade unit.

8. The razorblade assembly of claim 1, wherein said razorblade unit is lockable in pivot ranges via said connection.

9. The razorblade assembly of claim 1, wherein said razorblades further comprise tear-away covers.

10. The razorblade assembly of claim 1, wherein at least one of said faces further comprises moisturizing strips, angled razor positions, and wear sensors.

12. The razorblade assembly of claim 1, wherein said razorblade unit is removable and replaceable.

13. The razorblade assembly of claim 1, wherein said razorblade assembly is completely removable and replaceable.

14. A razorblade assembly, comprising:
a handle;
a shielding;
a razorblade unit, wherein said razorblade unit comprises multiple faces, wherein at least one of said faces comprises an integrated and guarded razorblade and wherein at least one of said faces has a blank face; and,
a connection between said handle and said razorblade unit, wherein said shielding is integrated with said handle, wherein said shielding covers the majority of said razorblade unit, wherein said razorblade unit is rotatable about an axis parallel to said faces beneath said shielding via said connection and wherein said faces are selectively lockable via said connection in an area uncovered by said shielding.

15. A razorblade assembly, comprising:
a handle;
a shielding;
a razorblade unit, wherein said razorblade unit comprises two parallel, opposing faces, wherein a first face comprises an integrated and guarded razorblade and wherein a second face has a blank face; and,
a connection between said handle and said razorblade unit, wherein said shielding is integrated with said handle, wherein said shielding covers the majority of said razorblade unit, wherein said razorblade unit is rotatable about an axis parallel to said faces beneath said shielding via said connection and wherein said faces are selectively lockable via said connection in an area uncovered by said shielding.
